(19) United States
(12) Patent Application Publication
(10) Pub. No.: US 2014/0133412 A1
(43) Pub. Date: May 15, 2014

(54) Interference mitigation technique for Heterogeneous/Homogeneous Networks employing dynamic Downlink/Uplink configuration

(71) Applicant: Centre of Excellence in Wireless Technology, Chennai, TN (US)

(72) Inventors: Klutto Milleth Jeniston Deviraj, Chennai (IN); Bhaskar Ramamurthi, Chennai (IN); Sunil Kaimalettu, Chennai (IN); Sivakishore Reddy Yerrapareddy, Kadappah (IN); Babu Narayanan Koonampilli Janardhnan, Chennai (IN); Nadeem Akhtar, Chennai (IN); Lakshmana Babu Vulusala, Kadapa (IN); Dhivagar Baskaran, Chennai (IN)

(73) Assignee: Centre of Excellence in Wireless Technology, Chennai, TN (US)

(21) Appl. No.: 14/074,620

(22) Filed: Nov. 7, 2013

(30) Foreign Application Priority Data
Nov. 9, 2012 (IN) 4708/CHE/2012

(51) Int. Cl. H04W 52/24; H04W 72/04

(52) U.S. Cl. CPC H04W 52/243; H04W 72/0473
USPC 370/329

(57) ABSTRACT

Embodiments disclosed herein relate to OFDM based data communication systems, and more particularly to mitigate Downlink-Downlink, Downlink-Uplink, Uplink-Downlink, Uplink-Uplink interference from same/adjacent channel in heterogeneous/homogeneous networks employing dynamic DL/UL configurations in OFDM based data communication systems.

### TECHNICAL FIELD

Embodiments herein relate to OFDM based data communication systems, and more particularly to mitigate Downlink-Downlink, Downlink-Uplink, Uplink-Downlink, Uplink-Uplink interference from same/adjacent channel in heterogeneous/homogeneous networks employing dynamic Downlink/Uplink configurations in OFDM based data communication systems. The present application is based on and claims priority from IN Application bearing No. 4708/CHE/2012 filed on 9 Nov. 2012, the disclosure of which is hereby incorporated by reference herein

### BACKGROUND

Transmission of data on a wireless channel requires pre-assigned frequency (spectrum). Spectrum being a very scarce natural resource and further limitation on its availability for data transmission, due to pre-occupation of some portion of the bands for other applications such as law enforcement, defense and space in some countries. In order to efficiently utilize this scarce commodity, the whole service area is divided into small regions called cells, which is further divided into sectors, and the available spectrum will be reused in every cells/sectors. Since the same frequency band is reused in different cells/sectors depending on the reuse factor, the user equipments (UEs) at the boundary between regions will be severely affected by interference. This phenomenon is called as co-channel interference (CCI).

There is another source of interference called as the adjacent channel interference (ACI), when multiple operators coexisting in the same geographical service area are assigned spectrum in adjacent bands. Normally, guard bands are provided by the governmental agencies between the multiple operators' allocation, and further the standards specification will allow some guard band at either edge of the bands. In LTE, 10% of the total channel bandwidth is reserved as guard band; however the standards provide scope for further increase or decrease in the guard band.

The above measures are sufficient in Frequency Division Duplex (FDD) systems where different channels (frequency bands) are used for the DownLink (DL) and UpLink (UL) transmissions. However, in Time Division Duplex (TDD) systems where the same channel (frequency band) is used for both DL and UL transmissions with orthogonality between the transmissions in the time domain; there is a stringent requirement of frame/time synchronization of the transmitted signals from multiple operators. Otherwise, this will lead to the well-known receiver saturation/blocking/desensitization problems due to the fact that one operator may perform DL, while the other may perform UL in the same geographical service area. Moreover, due to traffic requirements in a given service area at a particular point of time the operators may wish to dynamically change the DL/UL ratio of time resources and this may result in similar coexistence problems. Moreover in future, the policy of allocating spectrum may become independent of the technology used, in which case there may be situation where multiple operators may use the adjacent bands differently as either UL or DL.

In Long Term Evolution (LTE), a framework has been specified to support smaller cells within the Macro BS (eNode-B in LTE terminology) coverage area by deploying low power eNode-Bs or pico eNode-Bs, and these networks are called as Heterogeneous networks (Hetnets). LTE Release 11 also introduced a framework to support coordinated multipoint (CoMP) transmission by which multiple eNode-Bs may transmit or receive data to or from UE, respectively to enhance the capacity of these networks. However, when small cells are deployed by multiple operators in order to provide services inside commercial buildings or an apartment block with large number of flats it may increase the radiation levels inside the buildings. It is becoming a serious issue in countries like India, where electromagnetic radiation issues are raised by the general public and civil societies through various forums including the judiciary. Moreover, each operator deploying its own eNode-Bs may involve higher deployment and maintenance cost.

When multiple operators share the same infrastructure like tower etc., where the base stations of two or more operators are located in the same tower, the ACI will be severe. Similarly, when eNode-Bs operated by the same operator on the same channel with different DL-UL ratio, the CCI will be severe, the eNode-Bs could be of same or different type; for example, Macro only or Picos only or a mix of both. In all the above cases, the receiver may saturate/block, and the problem is referred to as TDD coexistence problem. This leads to the necessity to tackle mainly two types of ACI or CCI interference viz. eNode-B to eNode-B interference and UE-UE interference. The eNode-B to eNode-B interference will occur when closely located eNode-Bs of two operators transmits/receives data in the adjacent bands with operator A receiving data in the uplink while the operator B transmits data in the downlink and vice-versa. Similar interference will happen in the same operator scenario when one eNode-B receives data in the uplink while another eNode-B transmits data in the downlink. The UE to UE interference will occur when closely located UEs associated to two different operators transmit/receive data using adjacent bands with the UE associated to operator A is receiving while the UE associated to operator B is transmitting data and vice-versa. Similar interference will happen in the same operator scenario when closely located UEs served by different eNode-Bs of the same operator with the UE attached to the one eNode-B is receiving while the UE attached to the another eNode-B is transmitting.

### DETAILED DESCRIPTION

The embodiments herein and the various features and advantageous details thereof are explained more fully with reference to the non-limiting embodiments that are detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein enable multi-operator coexistence in heterogeneous/homogeneous networks in OFDM based data communication systems.

Embodiments herein enable a reduction in interference in heterogeneous/homogeneous networks in OFDM based data communication systems.

Consider operations in adjacent bands in adjacent cells (wherein operators of the cells may be the same operator or different operators). Each cell may comprise of at least one eNode-B or a group of eNode-Bs. In an embodiment herein, multiple cells may use a single eNode-B. eNode-B may comprise of one or more Macro eNode-B and/or pico eNode-Bs equipped with multiple antennas, where one or more antennas may be installed in same and/or different geographical (remote) locations. The eNode-Bs within the group and the antennas attached to each remote eNode-Bs may be connected by a wired link such as using an optical fibre, a coaxial cable, an Ethernet cable or any other equivalent means, or with a wireless link such as Microwave link, relays or any other equivalent means. The eNode-Bs may be a pico eNode-B or a low power or high power remote radio head end (RRH). Each group comprises of a centralized controller that includes a scheduler for the entire group of eNode-Bs. The individual eNode-Bs (both macro and pico) may use a common BS (Base Station) identity (BSID) or different BSIDs. The antennas attached to each eNode-Bs may be identified using the port ID, or they may have different BSID. The Port ID may be obtained from the CSI-RS (Channel State Information-Reference Signal), which are orthogonal in time, frequency, code or their combination.

On detecting eNode-B to eNode-B interference, the interference is mitigated by muting at least one resource block (RB) at the edges of either one of the operators' or both the operators bandwidth in subframes where simultaneous DL and UL transmission may occur when the DL-UL ratio of two operators are pre-defined and static.

Where multiple operators are involved, the operators may use dynamic DL-UL configuration. The eNode-B to eNode-B interference may be mitigated by muting at least one RB at the edges of either one of the operators' or both the operators bandwidth in subframes where simultaneous DL and UL are expected to occur for different combinations of DL-UL ratios.

In both static and dynamic configurations, a scheduler is used to mute the at least one RB at the edges of either one of the operators' or both the operators bandwidth in subframes where overlapping of DL-UL transmissions are expected to occur. The number of RBs to be muted depends on at least one of the distance between the eNode-Bs/UEs, transmit power, the guard band provided between the spectrum of the two operators and the transmit/receive filter characteristics. In the case of same operator operating in the same channel, in subframes where simultaneous DL and UL transmission is happening, appropriate RBs in subframes or entire subframes of some of the interfering eNode-Bs may be muted. The eNode-B to eNode-B interference may be sensed/measured by observing the power levels of the RBs. In multi-operator case, ACI (Adjacent Channel Interference) will be seen at the edges of the bands; whereas in single operator case, CCI (Co-Channel Interference) will be seen all over the bands depending on the scheduling. Further information on the source of interference, and also its presence may be obtained using the interference seen at every RB by an eNode-B, which is exchanged via backhaul to nearby eNode-Bs. With this information from multiple eNode-Bs and/or with the power level measured at various RBs in an eNode-B of interest, scheduling decisions like blanking of RBs/Subframes are made or DL power control is performed.

In an embodiment herein, at least one subframe may be configured as DL or UL by different eNode-Bs. These subframe types may be identified by comparing the interference or power levels with the subframes where the DL UL transmissions are aligned across all eNode-Bs. For example, in TD-LTE, the subframe before the special subframe is always a DL subframe, and the subframe immediately following the special subframe is always an UL subframe irrespective of the DL-UL configuration. This information may be used to select various UL power control parameters. Examples of the power control parameter are target received SINR, target received power.

The UE to UE interference may also be mitigated by appropriate scheduling of UE to receive data in the downlink with respect to the allocation of closely located UE of another operator performing uplink transmission. The allocations are done in such a way that the resources of both the UEs are sufficiently separated. In an embodiment herein, the allocation is at the middle portion of the band. In same operator's case, interference mitigation is done by scheduling the uplink transmission where there is no downlink transmission. The presence of a nearby UE performing uplink of another operator or from different eNode-Bs of the same operator will be identified by the UE receiving downlink data by exploiting the fact that uplink uses single carrier frequency division multiple access (SC-FDMA). It may be identified by listening to the uplink data or RS, and is fed back to its eNode-B to take appropriate scheduling decisions.

In an embodiment herein, radiation levels and deployment cost may be reduced by sharing the hardware resources and backhaul by more than one operator.

The different operators will transmit/receive their data and control channels using their respective transmitters/receivers, which may be eNode-Bs, RRHs or different set of antennas assigned to them. The number of antennas in a set may be as low as one. The available resources shared in time domain with the data transmission of different operators are orthogonal in time. In LTE systems, different operators will use pre-assigned DL and UL subframes for its data transmission using the same hardware, and this is configured a priori. When any one of the operator is transmitting its data in a subframe, the other operators will not transmit data in this subframe. This is done by configuring it as a blank subframe where no signal is present or as almost blank subframe (ABS) subframe where only the reference signals and control channels if present are transmitted for these operators. This may be done with or without appropriate signaling. However, the synchronization/broadcast channels of all the operators are transmitted simultaneously using their respective spectrum as per the LTE specifications from different RRHs or antennas. Otherwise, the synchronization/broadcast channel may be a different time frequency resources. Since these signals are present only in the middle 1.25 MHz, transmit power will not be an issue when only synchronization channels alone are transmitted in these subframes, and this will also help reducing ACI even if the multiple operator antennas are very close. The excess power available will be used to increase the reliability of cell identification and synchronization by transmitting the synchronization signals at a higher power.

The above solutions are mainly applicable to LTE systems with or without any proprietary modifications to the specifications; however it is not limited to LTE systems alone (For example, it could be applicable to multi-RAT scenarios such as coexistence between LTE and WiMAX operators or between WiMAX operators or between LTE operator and WiFi).

Embodiments herein propose reuse the existing backhaul available at the deployment sites resulting in a cost reduction by reducing the data transfer between the centralized controller and the RRH or set of antennas by moving the IFFT (Inverse Fast Fourier Transform))/FFT (Fast Fourier Transform) processing in the LTE transmit/receive chain, respectively to the RRH or set of antennas in the remote location. Also, when power control or power boosting is done at the eNode-B on the RS, appropriate scaling will be done on I and Q signals at the RB level or group of RB level to keep the dynamic range fixed further to reduce the number of bits to be transferred to the RRH or set of antennas in the remote location. The scaling information will be passed to the RRH or set of antennas in the remote location of the operator. Similarly, in the UL, equalization will be done at the RRH or set of antennas in the remote location, and appropriate scaling will be done on I and Q signals at the RB level or group of RB level to keep the dynamic range fixed further to reduce the number of bits to be transferred to the eNode-B. Some data compression techniques may be applied to further reduce the bits needed to transfer between the centralized controller and the RRH or set of antennas. One such method is by dropping or rounding of some of the least significant bits (LSBs) with graceful degradation in performance. The digital data corresponding to the modulation and information on the Zadoff-Chu sequence are transmitted to the RRH or to the set of antennas, and this sequence may be generated at the RRH or set of antennas in the remote location of the operator.

The embodiments disclosed herein may be implemented through at least one software program running on at least one hardware device and performing network management functions to control the network elements.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the embodiments as described herein.

We claim:

1. A method for reducing interference in an OFDM (Orthogonal Frequency Division Multiplexing) based communication system, the communication system comprising of at least one eNode-B, the method comprising of
muting at least one Resource Block (RB) in at least one of the band edges of at least one subframe, where the at least one RB may be affected by Adjacent Channel Interference (ACI) caused by overlapping DownLink (DL) and UpLink (UL) transmissions in adjacent channels; and
muting at least one Resource Block (RB) over entire band of operation of at least one subframe, where the at least one RB may be affected by Co-Channel Interference (CCI) caused by overlapping DownLink (DL) and UpLink (UL) transmissions in the same channel.

2. The method, as claimed in claim 1, wherein the adjacent channels belong to at least one of different network operators; and same network operators.

3. The method, as claimed in claim 1, wherein the RBs to be muted depends on at least one of distance between eNode-Bs, distance between UEs, transmit power, guard band between adjacent channels and characteristics of transmit/receive filter.

4. The method, as claimed in claim 1, wherein the muting is applied based on scheduling decisions.

5. The method, as claimed in claim 4, wherein the scheduling decisions are further based on at least one of power levels or interference levels of at least one RB each between a plurality of subframes.

6. The method, as claimed in claim 1, wherein the eNode-B identifies overlapping of DL/UL subframes of a plurality of eNode-Bs by comparing at least one of power levels or interference levels with subframes where DL and UL transmissions are aligned across all eNode-Bs in the communication system.

7. The method, as claimed in claim 6, wherein the at least one of power levels or interference levels is used to select at least one of the UL power control parameter; and
power boosting parameter.

8. The method, as claimed in claim 6, wherein the at least one of power levels or interference levels is used to perform scheduling to configure at least one of a fully blank subframe; and an almost blank subframe.

9. The method, as claimed in claim 1, wherein information on an interference source is obtained from the at least one RB by the eNode-B, wherein the information is exchanged with at least one other eNode-B using a backhaul link; wherein the backhaul is at least one of a wired link; and a wireless link.

10. The method, as claimed in claim 9, wherein the information is stored in a centralized controller, wherein the centralized controller is connected to a group of eNode-Bs.

11. The method, as claimed in claim 1, wherein the method further comprises of scheduling of a first User Equipment (UE) to receive data in DL with respect to the allocation of a second closely located UE of another operator performing uplink transmission such that the resources of the first UE and the second UE are sufficiently separated.

12. The method, as claimed in claim 11, wherein the method of scheduling comprises of listening to at least one of UL data or reference signal of the second UE;
feeding back information about at least one of the UL data; the reference signal; and
arrival time of the signal to the eNode-B; and
taking scheduling decisions based on the feedback information about at least one of the UL data or the reference signal.

13. An OFDM (Orthogonal Frequency Division Multiplexing) based communication system, the communication system configured for muting at least one Resource Block (RB) in at least one of the band edges of at least one subframe, where the at least one RB may be affected by Adjacent Channel Interference (ACI) caused by overlapping DownLink (DL) and UpLink (UL) transmissions in adjacent channels; and
muting at least one Resource Block (RB) over entire band of operation of at least one subframe, where the at least one RB may be affected by Co-Channel Interference (CCI) caused by overlapping DownLink (DL) and UpLink (UL) transmissions in the same channel.

14. The communication system, as claimed in claim 13, wherein the adjacent channels belong to at least one of different network operators; and same network operators.

15. The communication system, as claimed in claim 13, wherein the communication system is configured to mute RBs depending on at least one of distance between eNode-Bs, distance between UEs, transmit power, guard band between adjacent channels and characteristics of transmit/receive filter.

16. The communication system, as claimed in claim 13, wherein the communication system is configured to apply muting based on scheduling decisions.

17. The communication system, as claimed in claim 16, wherein the communication system is configured to base the scheduling decisions on at least one of power levels or interference levels of at least one RB each between a plurality of subframes.

18. The communication system, as claimed in claim 13, wherein the communication system comprises of at least one eNode-B, wherein the at least one eNode-B is configured to identify overlapping of DL/UL subframes of a plurality of eNode-Bs by comparing at least one of power levels or interference levels with subframes where DL and UL transmissions are aligned across all eNode-Bs in the communication system.

19. The communication system, as claimed in claim 18, wherein the communication system is configured to select at least one of the UL power control parameter; and a power boosting parameter using at least one of power levels or interference levels.

20. The communication system, as claimed in claim 18, wherein the communication system is configured to use the at least one of power levels or interference levels to perform scheduling to configure at least one of a fully blank subframe; and an almost blank subframe.

21. The communication system, as claimed in claim 13, wherein the communication system is configured to obtain information on an interference source from the at least one RB by the eNode-B, wherein the information is exchanged with at least one other eNode-B using a backhaul link; wherein the backhaul is at least one of a wired link; and a wireless link.

22. The communication system, as claimed in claim 21, wherein the communication system is configured to store the information in a centralized controller, wherein the centralized controller is connected to a group of eNode-Bs.

23. The communication system, as claimed in claim 13, wherein the communication system is further configured for scheduling of a first User Equipment (UE) to receive data in DL with respect to the allocation of a second closely located UE of another operator performing uplink transmission such that the resources of the first UE and the second UE are sufficiently separated.

24. The communication system, as claimed in claim 23, wherein the communication system is configured to perform scheduling by
listening to at least one of UL data or reference signal of the second UE;
feeding back information about at least one of the UL data; the reference signal; and
arrival time of the signal to the eNode-B; and
taking scheduling decisions based on the feedback information about at least one of the UL data or the reference signal.
